(19) United States
(12) Patent Application Publication
(10) Pub. No.: US 2012/0179523 A1
(43) Pub. Date: Jul. 12, 2012

(54) GAME-PLAYING AND PROVIDING CHARITABLE DONATIONS TO SELECTABLE LOCATIONS

(75) Inventor: Howard Ganz, North York (CA)

(73) Assignee: GANZ, Woodbridge (CA)

(21) Appl. No.: 13/343,974

(22) Filed: Jan. 5, 2012

Related U.S. Application Data
(60) Provisional application No. 61/430,718, filed on Jan. 7, 2011.

(51) Int. Cl. G06Q 20/10; G06Q 30/02

(52) U.S. Cl. 705/14.7; 705/39

(57) ABSTRACT

A social networking activity which provides charitable donations to a desired area/location. A computer server provides outputs from the social networking site that allows users to play a game on the social networking site. The game is such that the social networking site receives revenue on the social networking site as a result of a user playing the game. The user can select at least one charitable cause from among a plurality of selections of charitable causes, or at least one geographic location to receive at least some of that revenue.

This application claims priority from provisional application No. 61/430,718, filed Jan. 7, 2011, the entire contents of which are herewith incorporated by reference.

### BACKGROUND

Ganz markets a product which includes both real-world items, and their virtual replicas. Webkinz® stuffed animals allow obtaining both a plush animal or other “pet”, and a virtual representation of the pet on a website. Techniques of the website and user interaction are described in U.S. Publication No. 2005-0177428, the subject matter of which is herewith incorporated by reference.

In one embodiment of the Ganz system, as used on “Webkinz®” website, a unique registration code is associated with a plush toy or other item, and that registration code opens content on the website when entered on the website. The content that is opened includes an appearance of a character that resembles the toy.

A user can carry out various virtual activities on the website. When the user carries out these activities, they receive points that can be used within the activities of the website. For example, one way in which these points can be used is to buy items for an item that is registered, e.g., a virtual pet. The items can be used to customize the virtual pet. In one embodiment, the points are used as virtual cash. The points that are awarded can also or alternatively be used for other purposes.

### SUMMARY

An embodiment is described that allows interacting with the website, and playing a game. According to an embodiment, participating in the game allocates certain amounts of real money to be directed to donation targets. The user can select the donation target which receives the allocated money.

### BRIEF DESCRIPTION OF THE DRAWINGS

In the drawings:

FIG. 1 shows a system diagram of a game being played on a website; and

FIG. 2 shows a clickable map with different locations.

### DETAILED DESCRIPTION

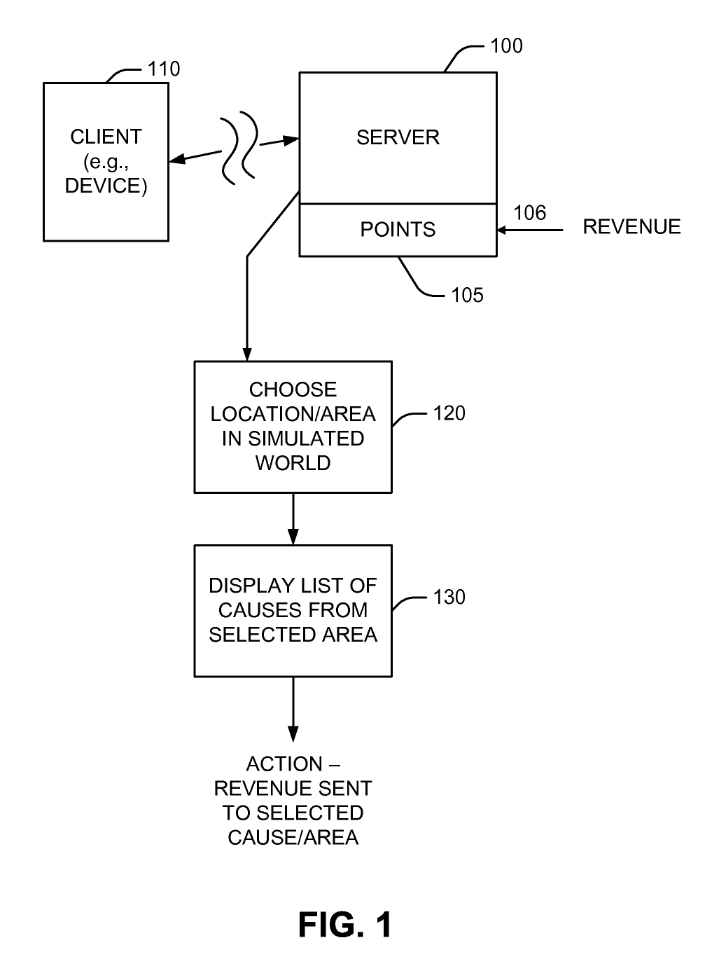

FIG. 1 illustrates an embodiment. A website 100 can be a conventional website running on a server computer, which allows one or many people to connect to the website and carry out actions on the website, including conventional website activities. The conventional website activities can include, for example, interacting with a user's virtual pets, registering new pets associated with a user account, and carrying out activities which can gain points or virtual currency on the website.

In one embodiment, the user can register a virtual product on the website by entering the code on the client computer that is indicative of the product. The code may be for example a unique code. The unique code is entered on the client computer, and information indicative of that code is communicated to the server computer. The server computer then registers a virtual product e.g. a virtual pet that corresponds to said code. The registration may be carried out in conjunction with a user account. That virtual product may then be displayed during the activity, e.g., during playing of the game. In one embodiment, the user can also customize the virtual product e.g. by buying clothing or otherwise changing the look of the virtual product. In one embodiment, the customized virtual product is shown as part of the playing of the game, and points can be obtained while playing the game or as a result of playing the game. Those points can be used to buy things for the product and hence further customize the virtual product.

In one embodiment, the virtual product can be animated during the playing of the game, e.g. the virtual product or customized virtual product may be part of the game itself.

The website keeps a score of points shown generically as 105. The website can be the Webkinz® website operated by Ganz. In another embodiment, there can be alternative website versions of the games—e.g., a Facebook® version of the games that can be played on the Facebook website to obtain points for use on or other rewards on the Webkinz® website.

The website connects via a publicly available network 110, e.g. the Internet, with any of a number of devices 120. In this embodiment, the device 120 is a mobile device such as a mobile phone such as an iPhone®.

One embodiment also enables accumulating real money by the users. This may be done using an advertising model, where advertisers pay for users to view pages. It may alternatively be done via a sharing of costs that are charged to the user in order to use the game. For example, the user may be shown certain kinds of advertisements when they perform certain actions in the game, and the server may receive revenue as shown generally as 106 for the viewing, and/or for click-throughs. The amounts received from advertising can be shared as described herein, so that small amounts of money may be transferred to, for example, a charity of choice as a result of the user's ad viewing or click-throughs.

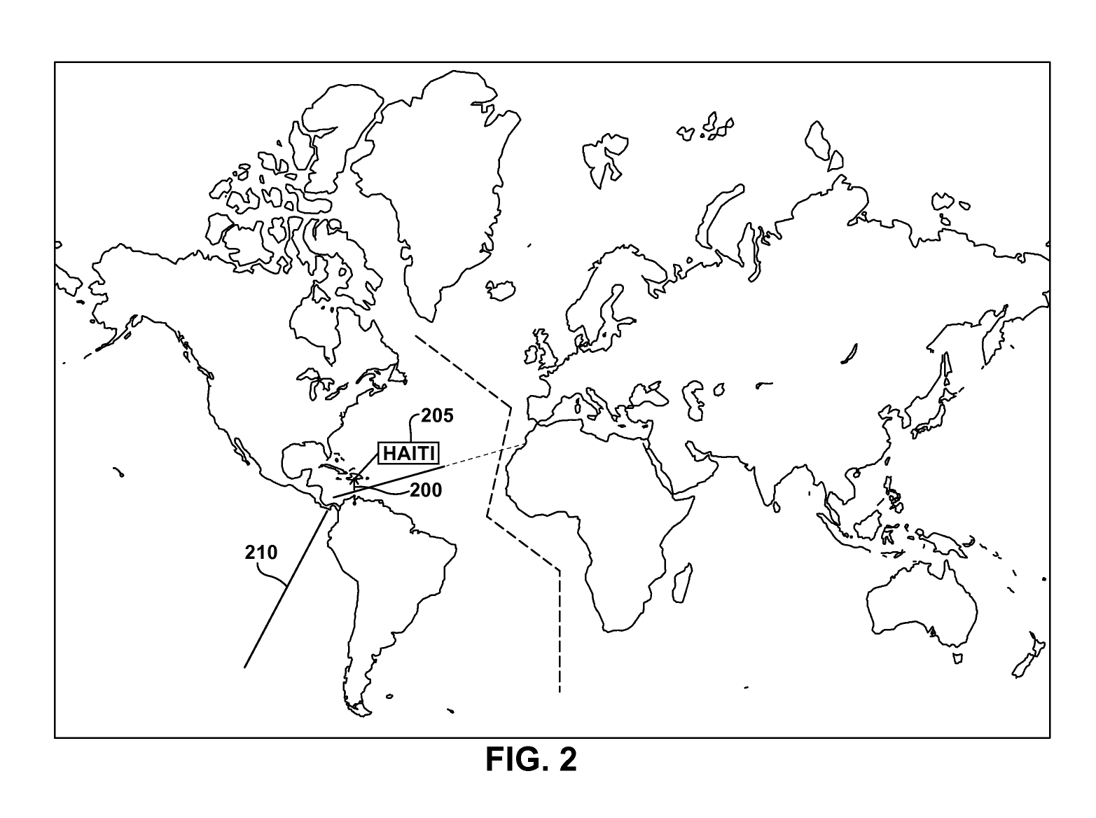

The server 100 runs a program to form a simulated world. This starts at 110, where the user can choose a location in the simulated world. FIG. 2 for example shows a map of areas that can be chosen, where the user can choose any of these locations as their current location to build a house or take some action. For example, FIG. 2 shows the cursor 200 over Haiti, which causes the map to open a pop-up description showing the word “Haiti”. This pop-up description can be for example a screen tip, or can actually be some kind of banner. The user can choose other locations, e.g., general locations within a boundary line shown as 210, allowing them to choose South America as a whole or to choose specific locations within that boundary line, for example choosing a specific country, state or city. By choosing the location, such as Haiti, the money that is received as revenue 106 can be sent to a location in that area and in particular, to a designated charitable organization in that area.

Referring again to FIG. 1, 130 shows displaying the list of causes or charitable organizations from the selected area. For example, if the user selects Haiti, they may be given choices of causes in that geographic location. For example, a choice can be “schools in Haiti”, “earthquake relief”, “housing in Haiti”, or others. If the user chooses Africa, they may be given Africa in general, as well as a list of specific causes in Africa to which donations may be made. Thereafter, when users carry out actions at 140, revenue from those actions is accumulated and then sent to the specific cause at the specific area.

The revenue may be sent, for example, under control of the server, at certain prescribed intervals.

An advantage of this system is that people of certain nationalities or national backgrounds might want the ability to help people who are in their home country. For example, those of Somali background might want to help Somalia.

In practice, for instance, a Farmville/Zynga game might let you build a house. In an embodiment, you can choose to build your house in India. As a result of choosing to build your house in India, a charitable donation is earmarked to be made to India.

Similarly, if a user selects to put their virtual house in a town located in virtual Haiti, a charitable donation (e.g., a prescribed amount) is made to the real country of Haiti. This empowers the users to decide where they want to donate and allows an average person to select charitable causes while participating in a social networking activity.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example the above has described this system being operated as a computer based application, however it should be understood that this can be operated on any computer, including a mobile device. For example in one embodiment, this can be operated as an off-line application on a laptop for example during a time that does not have a connection to the Internet.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PC1”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wi-Fi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer program product comprising a computer-usable nontransitory tangible medium having a computer-readable program code embodied therein, said computer-readable program code adapted to be executed to implement operations of providing information on a social networking site that allows users to play a game on the social networking site,
receiving revenue on the social networking site as a result of a user playing the game;
controlling selecting by the user at least one charitable cause from among a plurality of selections, said selecting carried as part of playing the game on the social networking website; and
directing at least a portion of the revenue to said at least one charitable causes that have been selected.

2. A product as in claim 1, wherein said operations comprise registering a user on a server computer system, and associating information indicative of the registering with an account on the server computer system, wherein said account on the server computer system includes information indicative of at least one charitable cause which has been selected by the user.

3. A product as in claim 2, wherein said operations further comprise:
providing, to a user computer, information indicative of a number of different charitable causes which can be selected; and
receiving a selection of one of said different charitable causes, wherein said one of said different charitable causes is stored as said at least one charitable cause associated with said account.

4. A product as in claim 3, wherein said providing information comprises providing a plurality of geographic locations which can be selected, and wherein said charitable causes are associated with respective ones of said plurality of geographic locations.

5. A product as in claim 4, wherein said plurality of geographic locations are locations on a map that can be selected on the map.

6. A product as in claim 4, wherein said plurality of geographic locations are countries.

7. A product as in claim 2, wherein said registering comprises receiving a code on the server computer system, where said code represents a specific item.

8. A product as in claim 7, wherein said code represents a specific virtual product used during the playing of a game on the server computer system.

9. A product as in claim 2, wherein said revenue is obtained from advertising carried out as part of playing the game.

10. A product as in claim 4, further comprising instructions that enable playing a game, wherein said game is a simulated world game, and said simulated world game is carried out in a simulated geographic location based on a geographic location that has been selected.

11. A product as in claim 8, wherein said playing of the game includes customizing the specific virtual product.

12. A computer program product comprising a computer-usable nontransitory tangible medium having a computer-readable program code embodied therein, said computer-readable program code adapted to be executed to implement operations of:
registering a user on a server computer system;
providing said user with a number of different selections of geographic locations where charitable donations can be made;
receiving a selection of one of said geographic locations;
playing a game using the server computer system involving said user, using said one geographic location as part of said game; and
receiving an indication of income generated by playing said game; and
providing at least a part of said income to a charity associated with said one geographic location selected by said user.

13. A product as in claim 12, wherein said providing said user with the number of different selections of geographic locations comprises providing a picture of a map with locations that can be selected on the map.

14. A product as in claim 13, wherein said geographic locations are countries.

15. A product as in claim 12, wherein said registering comprises receiving a code on the server computer system, where said code represents a specific item.

16. A product as in claim 15, wherein said specific item corresponds to a specific virtual product used during the playing of the game using the server computer system.

17. A product as in claim 16, wherein said playing of the game includes customizing the specific virtual product.

18. A method of playing a game on a social network website, comprising:
providing outputs to the social networking site that allows users to play a game on the social networking site,
receiving revenue on the social networking site as a result of a user playing the game;
accepting a selection from the user of at least one charitable cause from among a plurality of selections of charitable causes, said accepting being associated with said playing the game on the social networking website; and
directing at least a portion of the revenue from the social networking website to said at least one charitable cause that have been selected.

19. A method as in claim 18, wherein said providing information comprises providing a plurality of geographic locations which can be selected as areas for said charitable causes, said locations each associated with at least one charitable cause, and where said directing is to said at least one charitable cause.

20. A method as in claim 19, wherein said plurality of geographic locations are locations on a map that can be selected on the map.

21. A method as in claim 19, wherein said plurality of geographic locations are countries.

22. A method as in claim 19, wherein the information further comprises instructions that enable playing a game, wherein said game is a simulated world game, and said simulated world game is carried out in a simulated geographic location based on a geographic location that has been selected.

23. A method of playing a game on a social network website, comprising:
receiving information on a user computer from the social networking site, that allows a user on the user computer to play a game on the social networking site, said game being one that creates revenue on the social networking site as a result of a user playing the game; and
selecting, from the user computer, at least one charitable cause from among a plurality of selections of charitable causes, to be associated with said playing the game on the social networking website and that is to receive at least a portion of the revenue from the social networking website to said at least one charitable cause that have been selected.

24. A method as in claim 23, wherein said selecting comprises providing a plurality of geographic locations which can be selected as areas for said charitable causes, said locations each associated with at least one charitable cause, and where said directing is to said at least one charitable cause.

25. A method as in claim 24, wherein said plurality of geographic locations are locations on a map that can be selected on the map.

26. A method as in claim 24, wherein said plurality of geographic locations are countries.

27. A method as in claim 24, further comprising playing a simulated world game, and said simulated world game is carried out in a simulated geographic location based on a geographic location that has been selected.
